(19) United States
(12) Patent Application Publication
(10) Pub. No.: US 2026/0353456 A1
(43) Pub. Date: Nov. 5, 2026

(54) APPARATUS, SYSTEM, AND METHOD OF MEASUREMENT BASED ON FRAME EXCHANGE

(71) Applicant: Intel Products IP LLC, Santa Clara, CA (US)

(72) Inventor: Laurent Cariou, Milizac (FR)

(73) Assignee: Intel Products IP LLC, Santa Clara, CA (US)

(21) Appl. No.: 19/711,498

(22) Filed: Jun. 17, 2026

Related U.S. Application Data
(60) Provisional application No. 63/849,271, filed on Jul. 23, 2025.

(51) Int. Cl. H04W 74/0816

(52) U.S. Cl. CPC H04W 74/0816

(57) ABSTRACT

For example, a non Access Point (AP) (non-AP) station (STA) may be configured to transmit a Request to Send (RTS) frame; and determine measurement information based on a measurement of a Clear to Send (CTS) frame received from an AP based on the RTS frame. For example, an AP may be configured to process an RTS frame received from a non-AP STA; and to transmit a CTS frame based on the RTS frame. For example, the AP may be configured to transmit the CTS frame using a beacon frame transmit power used by the AP for transmission of beacon frames.

### CROSS REFERENCE

This Application claims the benefit of and priority from U.S. Provisional Patent Application No. 63/849,271 entitled “SHORT RECEIVED SIGNAL STRENGTH INDICATOR (RSSI) PROBE FOR CANDIDATES ACCESS POINTS (APS)”, filed Jul. 23, 2025, the entire disclosure of which is incorporated herein by reference.

### BACKGROUND

Devices in a wireless communication system may be configured to communicate various types of frames, which may include, for example, beacon frames, data frames, control frames, or the like.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic flow-chart illustration of a method of determining measurement information, in accordance with some demonstrative aspects.

FIG. 3 is a schematic flow-chart illustration of a Request to Send (RTS)/ Clear to Send (CTS) exchange, in accordance with some demonstrative aspects.

FIG. 4 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2024 (IEEE 802.11-2024, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, April, 2025); and/or IEEE 802.11bn (IEEE P 802.11bn/D1.4 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 6: Enhancements for ultra-high reliability (UHR), April 2026)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stack, buffers, and/or the like, coupled to the one or more processors, e.g., as necessary to execute the logic.

Some demonstrative aspects may be used in conjunction with a WLAN, e.g., a Wi-Fi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 GHz and 300 GHz, for example, a frequency band above 45 GHz, e.g., a 60 GHz frequency band, and/or any other mmWave frequency band. Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink (UL) frames using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

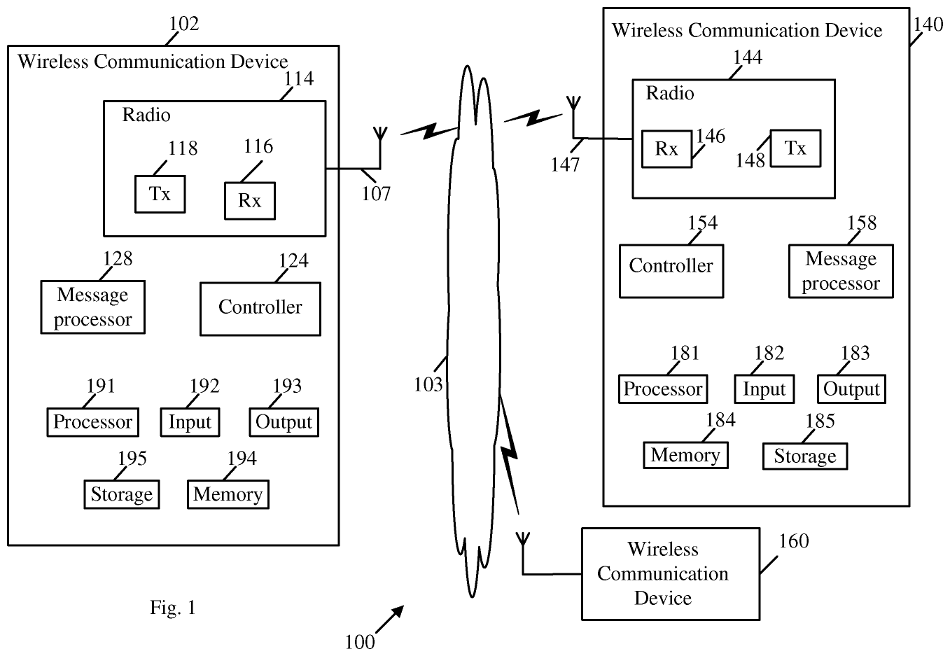

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, an RF channel, a Wi-Fi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10GHz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include one or more radios 114, and/or device 140 may include one or more radios 144.

In some demonstrative aspects, radios 114 and/or radios 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mmWave band, a 5G band, an S 1G band, and/or any other band.

In some demonstrative aspects, radios 114 and/or 144 may include, or may be associated with one or more antennas.

In some demonstrative aspects, device 102 may include one or more antennas 107, and/or device 140 may include one or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102, device 140, and/or device 160 may be configured to perform one or more operations, and/or functionalities of a Wi-Fi 8 STA.

In other aspects, for example, devices 102, 140 and/or 160 may be configured to perform one or more operations, and/or functionalities of an Ultra High Reliability (UHR) STA.

In other aspects, for example, devices 102, 140, and/or 160 may be configured to perform one or more operations, and/or functionalities of any other additional or alternative type of STA.

In other aspects, device 102, device 140, and/or device 160 may include, operate as, perform the role of, and/or perform one or more functionalities of, any other wireless device and/or station, e.g., a WLAN STA, a Wi-Fi STA, and the like.

In some demonstrative aspects, device 102, device 140, and/or device 160 may be configured operate as, perform the role of, and/or perform one or more functionalities of, an Access Point (AP), e.g., a High Throughput (HT) AP STA, a High Efficiency (HE) AP STA, an EHT AP STA and/or a UHR AP STA.

In some demonstrative aspects, device 102, device 140, and/or device 160 may be configured to operate as, perform the role of, and/or perform one or more functionalities of, a non-AP STA, e.g., an HT non-AP STA, an HE non-AP STA, an EHT non-AP STA and/or a UHR non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 160 may be configured to communicate in an HT network, an HE network, an EHT network, a UHR network, and/or any other network.

In some demonstrative aspects, devices 102, 140 and/or 160 may be configured to operate in accordance with one or more Specifications, for example, including one or more IEEE 802.11 Specifications, e.g., an IEEE 802.11-2024 Specification, an IEEE 802.11bn Specification, and/or any other specification and/or protocol.

In some demonstrative aspects, device 102, device 140, and/or device 160 may include, operate as, perform a role of, and/or perform the functionality of, a Multi-Link Device (MLD). For example, device 102 may include, operate as, perform a role of, and/or perform the functionality of, at least one MLD, device 140 may include, operate as, perform a role of, and/or perform the functionality of, at least one MLD, and/or device 160 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102, device 140, and/or device 160 may be configured to operate as, perform the role of, and/or perform one or more functionalities of, an AP MLD.

In some demonstrative aspects, device 102, device 140, and/or device 160 may be configured to operate as, perform the role of, and/or perform one or more functionalities of, a non-AP MLD.

In other aspects, device 102, device 140, and/or device 160 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In some demonstrative aspects, device 102, device 140, and/or device 160 may include, operate as, perform a role of, and/or perform the functionality of, one or more AP STAs and/or one or more non-AP STAs. In one example, device 102 may include, operate as, perform a role of, and/or perform the functionality of, at least one AP STA, and/or device 140 may include, operate as, perform a role of, and/or perform the functionality of, at least one non-AP STA.

In some demonstrative aspects, device 102 may include, operate as, perform a role of, and/or perform the functionality of, a first STA, e.g., an AP STA or a non-AP STA.

In some demonstrative aspects, device 140 may include, operate as, perform a role of, and/or perform the functionality of, a second STA, e.g., an AP STA or a non-AP STA.

In some demonstrative aspects, device 160 may include, operate as, perform a role of, and/or perform the functionality of, a third STA, e.g., an AP STA or a non-AP STA.

In other aspects, device 102, device 140, and/or device 160 may include, operate as, perform a role of, and/or perform the functionality of any other additional or alternative type of STA.

In some demonstrative aspects, device 102, device 140, and/or device 160 may be configured to implement one or more operations and/or functionalities of one or more measurement mechanisms, which may be configured to support measurements by a non-AP STA, e.g., as described below.

In some demonstrative aspects, device 102, device 140, and/or device 160 may be configured to implement one or more operations and/or functionalities of one or more measurement mechanisms, which may be configured to support measurements by a non-AP STA based on one or more frames received from one or more APs, e.g., as described below.

In some demonstrative aspects, device 102, device 140, and/or device 160 may be configured to implement one or more operations and/or functionalities of one or more measurement mechanisms, which may be configured to support measurements by a non-AP STA based on a measurement exchange between the non-AP STA and an AP, e.g., as described below.

In some demonstrative aspects, device 102, device 140, and/or device 160 may be configured to implement one or more operations and/or functionalities of one or more measurement mechanisms, which may be configured to provide a technical solution to support mobility, e.g., substantially smooth mobility, of the non-AP STA for transitions between APs, e.g., in different locations, e.g., as described below.

In some demonstrative aspects, device 102, device 140, and/or device 160 may be configured to implement one or more operations and/or functionalities of one or more measurement mechanisms, which may be configured to provide a technical solution to support mobility, e.g., substantially smooth mobility, of the non-AP STA between APs, for example, with zero or low latency, and/or with zero or low packet losses, e.g., as described below.

In some demonstrative aspects, device 102, device 140, and/or device 160 may be configured to implement one or more operations and/or functionalities of one or more measurement mechanisms, which may be configured to provide a technical solution to support improved transition of a non-AP STA/non-AP MLD, for example, from one AP/AP MLD to a target AP/AP MLD, for example, when the client has already identified the target AP/AP MLD, e.g., as described below.

For example, in order to identify the target AP/AP MLD among candidate APs/AP MLDs, the STA may receive one or more Basic Service Set (BSS) Transition Management (BTM) requests from its associated AP/AP MLD.

For example, the one or more BTM requests may include one or more information elements, e.g., neighbor report elements, describing candidate APs/AP MLDs. For example, the one or more information elements may contain some information about these APs/AP MLDs, e.g., including an operating channel, or the like. For example, the one or more information elements may not include all information needed by the STA.

For example, the STA may be required to go and scan the corresponding APs/AP MLDs, for example, in order to collect information, e.g., any remaining important information, and/or to perform one or more measurements based on communications from the corresponding APs/AP MLDs. For example, the STA may measure a Receive Signal Strength Indicator (RSSI) and/or any other measurements for the candidate APs/AP MLDs.

In one example, these measurements may be performed through a Probe Request frame transmitted by the STA to the candidate AP, and the AP then responds with a Probe Response when it is ready to respond, e.g., the AP may not respond a Short Inter Frame Space (SIFS) after the request, e.g., the AP may respond more than a SIFS after the request.

In some demonstrative aspects, for example, in some use cases and/or implementations there may be a need to provide a technical solution to support efficient implementation of the measurements by the STA, e.g., as described below.

For example, configuring the STA to perform measurements based on beacons from AP may result in a high overhead, due to the length of the beacons and/or large amount of information included in the beacons.

In some demonstrative aspects, device 102, device 140, and/or device 160 may be configured to implement one or more operations and/or functionalities of one or more measurement mechanisms, which may be configured to support measurements by a non-AP STA based on an exchange of messages having a predefined type and/or configuration, e.g., as described below.

In some demonstrative aspects, device 102, device 140, and/or device 160 may be configured to implement one or more operations and/or functionalities of one or more measurement mechanisms, which may be configured to support measurements by a non-AP STA based on a Request to Send (RTS)/Clear to Send (CTS) (RTS/CTS) exchange between the non-AP STA and an AP, e.g., as described below.

In some demonstrative aspects, controller 154 may be configured to control, trigger, cause, and/or instruct a non-AP STA implemented by device 140 to transmit a Request to Send (RTS) frame, e.g., as described below.

In some demonstrative aspects, controller 154 may be configured to control, trigger, cause, and/or instruct the non-AP STA implemented by device 140 to determine measurement information based on a measurement of a Clear to Send (CTS) frame received from an AP based on the RTS frame, e.g., as described below.

In some demonstrative aspects, controller 154 may be configured to control, trigger, cause, and/or instruct the non-AP STA implemented by device 140 to determine the measurement information including power-measurement information based on a power measurement of the CTS frame, e.g., as described below.

In some demonstrative aspects, controller 154 may be configured to control, trigger, cause, and/or instruct the non-AP STA implemented by device 140 to determine the measurement information including energy information based on an energy measurement of the CTS frame, e.g., as described below.

In some demonstrative aspects, controller 154 may be configured to control, trigger, cause, and/or instruct the non-AP STA implemented by device 140 to determine the measurement information including Receive Signal Strength Indicator (RSSI) information based on an RSSI measurement of the CTS frame, e.g., as described below.

In some demonstrative aspects, controller 154 may be configured to control, trigger, cause, and/or instruct the non-AP STA implemented by device 140 to determine the measurement information, for example, based on measurement of a plurality of CTS frames from a plurality of APs, e.g., as described below.

In some demonstrative aspects, controller 154 may be configured to control, trigger, cause, and/or instruct the non-AP STA implemented by device 140 to process the CTS frame, for example, to identify parameter information corresponding to a setting of one or more parameters of the AP, e.g., as described below.

In some demonstrative aspects, controller 154 may be configured to control, trigger, cause, and/or instruct the non-AP STA implemented by device 140 to process the CTS frame, for example, to identify the parameter information including bandwidth information of a Basic Service Set (BSS) operating bandwidth of the AP, e.g., as described below.

In some demonstrative aspects, controller 154 may be configured to control, trigger, cause, and/or instruct the non-AP STA implemented by device 140 to process the CTS frame, for example, to identify the parameter information including spatial stream information of one or more spatial streams utilized by the AP, e.g., as described below.

In some demonstrative aspects, controller 154 may be configured to control, trigger, cause, and/or instruct the non-AP STA implemented by device 140 to process the CTS frame, for example, to identify the parameter information including channel load information, e.g., as described below.

In some demonstrative aspects, controller 154 may be configured to control, trigger, cause, and/or instruct the non-AP STA implemented by device 140 to process the CTS frame, for example, to identify the parameter information including AP MLD information corresponding to an AP MLD with which the AP is affiliated, e.g., as described below.

In some demonstrative aspects, controller 154 may be configured to control, trigger, cause, and/or instruct the non-AP STA implemented by device 140 to process the CTS frame, for example, to identify the parameter information including security information, e.g., as described below.

In some demonstrative aspects, controller 154 may be configured to control, trigger, cause, and/or instruct the non-AP STA implemented by device 140 to process the CTS frame, for example, to identify any other additional or alternative suitable type parameter information.

In some demonstrative aspects, controller 154 may be configured to control, trigger, cause, and/or instruct the non-AP STA implemented by device 140 to process an information element from the AP, for example, to identify which parameter information is included in the CTS frame, e.g., as described below.

In some demonstrative aspects, controller 154 may be configured to control, trigger, cause, and/or instruct the non-AP STA implemented by device 140 to transmit to the AP a request configured to indicate to the AP which requested parameter information is requested by the non-AP STA, e.g., as described below.

In some demonstrative aspects, controller 154 may be configured to control, trigger, cause, and/or instruct the non-AP STA implemented by device 140 to transit the RTS frame as a unicasted frame, e.g., as described below.

In some demonstrative aspects, controller 154 may be configured to control, trigger, cause, and/or instruct the non-AP STA implemented by device 140 to configure the RTS frame addressed to the AP, e.g., as described below.

In some demonstrative aspects, controller 154 may be configured to control, trigger, cause, and/or instruct the non-AP STA implemented by device 140 to transit the RTS frame as a broadcasted frame, e.g., as described below.

In some demonstrative aspects, controller 154 may be configured to control, trigger, cause, and/or instruct the non-AP STA implemented by device 140 to receive CTS frame separated from the RTS frame by a Short Inter Frame Space (SIFS), e.g., as described below.

In some demonstrative aspects, controller 154 may be configured to control, trigger, cause, and/or instruct the non-AP STA implemented by device 140 to transmit a measurement report including the measurement information, e.g., as described below.

In some demonstrative aspects, controller 154 may be configured to control, trigger, cause, and/or instruct the non-AP STA implemented by device 140 to transmit the RTS frame, for example, based on a request from a first AP, e.g., as described below.

In some demonstrative aspects, controller 154 may be configured to control, trigger, cause, and/or instruct the non-AP STA implemented by device 140 to process the CTS frame received from a second AP, e.g., as described below.

In some demonstrative aspects, controller 154 may be configured to control, trigger, cause, and/or instruct the non-AP STA implemented by device 140 to transmit the measurement information to the first AP, e.g., as described below.

In other aspects, controller 154 may be configured to control, trigger, cause, and/or instruct the non-AP STA implemented by device 140 to communicate the RTS frame, the CTS frame, the measurement information, and/or any other additional or alternative message and/or frame with the same AP and/or with one or more other APs.

In some demonstrative aspects, controller 124 may be configured to control, trigger, cause, and/or instruct an AP implemented by device 102 to process a Request to Send (RTS) frame received from a non-AP STA, e.g., as described below.

In some demonstrative aspects, controller 124 may be configured to control, trigger, cause, and/or instruct an AP implemented by device 102 to transmit a Clear to Send (CTS) frame based on the RTS frame, for example, by transmitting the CTS frame using a beacon frame transmit power used by the AP for transmission of beacon frames, e.g., as described below.

In some demonstrative aspects, controller 124 may be configured to control, trigger, cause, and/or instruct an AP implemented by device 102 to configure the CTS frame to include parameter information corresponding to a setting of one or more parameters of the AP, e.g., as described below.

In some demonstrative aspects, controller 124 may be configured to control, trigger, cause, and/or instruct an AP implemented by device 102 to configure the CTS frame to include the parameter information including bandwidth information of a BSS operating bandwidth of the AP, e.g., as described below.

In some demonstrative aspects, controller 124 may be configured to control, trigger, cause, and/or instruct an AP implemented by device 102 to configure the CTS frame to include the parameter information including spatial stream information of one or more spatial streams utilized by the AP, e.g., as described below.

In some demonstrative aspects, controller 124 may be configured to control, trigger, cause, and/or instruct an AP implemented by device 102 to configure the CTS frame to include the parameter information including channel load information, e.g., as described below.

In some demonstrative aspects, controller 124 may be configured to control, trigger, cause, and/or instruct an AP implemented by device 102 to configure the CTS frame to include the parameter information including AP MLD information corresponding to an AP MLD with which the AP is affiliated, e.g., as described below.

In some demonstrative aspects, controller 124 may be configured to control, trigger, cause, and/or instruct an AP implemented by device 102 to configure the CTS frame to include the parameter information including security information, e.g., as described below.

In some demonstrative aspects, controller 124 may be configured to control, trigger, cause, and/or instruct an AP implemented by device 102 to configure the CTS frame to include any other suitable additional or alternative type of parameter information.

In some demonstrative aspects, controller 124 may be configured to control, trigger, cause, and/or instruct an AP implemented by device 102 to transmit an information element, which may be configured, for example, to identify which parameter information is included in the CTS frame, e.g., as described below.

In some demonstrative aspects, controller 124 may be configured to control, trigger, cause, and/or instruct an AP implemented by device 102 to process a request from the non-AP STA, for example, to identify which requested parameter information is requested by the non-AP STA, e.g., as descried below.

In some demonstrative aspects, controller 124 may be configured to control, trigger, cause, and/or instruct an AP implemented by device 102 to process the RTS frame as a unicasted frame, e.g., as described below.

In some demonstrative aspects, the RTS frame may be addressed to the AP, e.g., as described below.

In some demonstrative aspects, controller 124 may be configured to control, trigger, cause, and/or instruct an AP implemented by device 102 to process the RTS frame as a broadcast frame, e.g., as described below.

In some demonstrative aspects, controller 124 may be configured to control, trigger, cause, and/or instruct an AP implemented by device 102 to transmit the CTS frame separated from the RTS frame by a SIFS, e.g., as described below.

In other aspects, controller 124 may be configured to control, trigger, cause, and/or instruct an AP implemented by device 102 to transmit the CTS frame separated from the RTS frame by any other suitable Inter-Frame Space (IFS) and/or time duration.

In some demonstrative aspects, device 102, device 140, and/or device 160 may be configured to implement one or more operations and/or functionalities of a measurement mechanism, which may be configured to support measurements by a non-AP STA, e.g., as described below.

In some demonstrative aspects, device 102, device 140, and/or device 160 may be configured to implement one or more operations and/or functionalities of a measurement mechanism, which may be configured to support measurements by a non-AP STA based on one or more frames received from one or more APs, e.g., as described below.

In some demonstrative aspects, device 102, device 140, and/or device 160 may be configured to implement one or more operations and/or functionalities of a measurement mechanism, which may be configured to support measurements by a non-AP STA based one or more message exchanges with one or more APs, e.g., as described below.

In some demonstrative aspects, it may be defined, e.g., according to the measurement mechanism, that a frame exchange, e.g., a short frame exchange, is to be performed between a STA and a candidate AP, e.g., as described below.

In some demonstrative aspects, it may be defined, e.g., according to the measurement mechanism, that the STA is to send an initial frame to the AP, and the AP is to respond to the initial frame, for example, a SIFS time after the initial frame, e.g., as described below.

In some demonstrative aspects, it may be defined, e.g., according to the measurement mechanism, that the frame exchange is to include an RTS/CTS exchange, or is to be performed similar to an RTS/CTS exchange, e.g., as described below.

In some demonstrative aspects, it may be defined, e.g., according to the measurement mechanism, that the initial frame and/or the response may be configured as control frames, e.g., similar to RTS/CTS frames, and/or management frames, e.g., similar to probe request/response frames.

In other aspects, it may be defined, e.g., according to the measurement mechanism, that the initial frame and/or the response may be configured according to any other suitable frame format and/or type.

In some demonstrative aspects, it may be defined, e.g., according to the measurement mechanism, that the initial frame may be, e.g., should be, unicasted and addressed to the target AP.

In some demonstrative aspects, it may be defined, e.g., according to the measurement mechanism, that the response frame from the AP may be unicasted and addressed to the initiating STA.

In some demonstrative aspects, it may be defined, e.g., according to the measurement mechanism, that the response frame may be broadcasted from the AP, for example, to provide a technical solution to support other STAs to receive the information from the AP.

In some demonstrative aspects, it may be defined, e.g., according to the measurement mechanism, that the initial frame and/or the response frame may be configured to reuse and/or modify one or more types of existing frames, e.g., as described below.

For example, it may be defined, e.g., according to the measurement mechanism, that the initial frame and/or the response frame may be configured to reuse and/or modify RTS/CTS frames.

For example, it may be defined, e.g., according to the measurement mechanism, that the initial frame and/or the response frame may be configured to reuse and/or modify Multi-User (MU) MU-RTS/CTS frames.

For example, it may be defined, e.g., according to the measurement mechanism, that the initial frame and/or the response frame may be configured to reuse and/or modify a Buffer Status Report Poll (BSRP) Trigger Frame (TF) and/or a Multi-STA (M-STA) Block Acknowledgement (BA).

For example, it may be defined, e.g., according to the measurement mechanism, that the initial frame and/or the response frame may be configured to reuse and/or modify Probe Request/Probe Response frames, or the like.

In some demonstrative aspects, it may be defined, e.g., according to the measurement mechanism, that the initial frame and/or the response frame may be configured as new types of frames, such as, for example, a Short Probe Request frame and/or Short Probe Response frame, e.g., as described below.

In some demonstrative aspects, it may be defined, e.g., according to the measurement mechanism, that the response frame may be transmitted by the AP, for example, using the same transmit power it uses to transmit its Beacon frames. For example, the AP may be configured to transmit the response frame with the transmit power it uses to transmit its Beacon frames, for example, to provide a technical solution to allow the STA to measure the RSSI, for example, in a similar manner as it does when receiving a Beacon frame or a Probe Response frame.

In some demonstrative aspects, it may be defined, e.g., according to the measurement mechanism, that the response frame may be configured as a simple CTS frame. For example, the AP may transmit the CTS without including any additional information in the CTS.

In some demonstrative aspects, it may be defined, e.g., according to the measurement mechanism, that the response frame may also include a list of additional parameters, e.g., as described below.

In some demonstrative aspects, the information of the additional parameters may that may be configured to include information that may be useful for the STA to complement the information it gets through the Neighbor Report from other APs in the same Extended Service Set (ESS).

In some demonstrative aspects, it may be defined, e.g., according to the measurement mechanism, that the response frame may be configured to include a list of parameters, which may be mandated, for example, by a suitable IEEE 802.11 Specification, or the like.

In some demonstrative aspects, it may be defined, e.g., according to the measurement mechanism, that the response frame may be configured to include information of one or more parameters, which may be, for example, defined, configured and/or parametrized, for example, per Basic Service Set (BSS) or per ESS.

In some demonstrative aspects, it may be defined, e.g., according to the measurement mechanism, that the response frame may be configured to include information of one or more of the following parameters:
BSS operating bandwidth (BW);
Number of Spatial Streams;
Channel Load information, e.g., in the form of a channel load information element;
AP MLD information, e.g., including a Reduced Neighbor Report including all APs affiliated with the same AP MLD, or the like;
Security information, e.g., Authentication and Key Management (AKM) information, or the like; and/or
any other suitable information.

In some demonstrative aspects, it may be defined, e.g., according to the measurement mechanism, that the AP may be configured to advertise a list of parameters, and/or which parameters are to be included in the response frame, for example, in case the list of parameters that are included in the response frame are not mandated in a specification.

In some demonstrative aspects, it may be defined, e.g., according to the measurement mechanism, that the list of parameters, and/or which parameters are to be included in the response frame, may be advertised by the ESS, for example, as part of an ESS report element.

For example, the ESS report element may be configured to include a new field, e.g., a field called “Parameters Included in Short Probe Response” or the like.

For example, the ESS report element may be configured to include a field, e.g., the Parameters Included in Short Probe Response field, which may be configured to include a Bitmap.

For example, the bitmap may be configured such that a bit, e.g., each bit, in the bitmap may correspond to a parameter. For example, a bit in the bitmap that corresponds to a particular parameter may be set to 1, for example, to indicate that the information corresponding to the particular parameter is to be provided by an AP in a response frame, e.g., in every Short Probe Response frame and/or every CTS frame.

For example, the bit in the bitmap that corresponds to the particular parameter may be set to 1, for example, to indicate that the information corresponding to the particular parameter is to be provided in a response frame, e.g., in every Short Probe Response frame and/or every CTS frame, that is transmitted by APs that are part of the same ESS and/or same roaming domain.

In some demonstrative aspects, it may be defined, e.g., according to the measurement mechanism, that a STA associated with an AP of the ESS may be allowed to request that some additional information is provided in the response frames, e.g., the Short Probe Response frames and/or CTS frames, from APs in the ESS.

In some demonstrative aspects, it may be defined, e.g., according to the measurement mechanism, that a STA associated with an AP of the ESS may configure a management frame, e.g., a Short Probe Additional Information Request management frame, that is addressed to the associated AP part of an ESS to include a field, e.g., the “Parameters Included in Short Probe Response” field, and with the bits set to 1, for example, for all parameters that the STA requests to include in the response frames. Any other suitable frame and/or field type and/or format may be utilized.

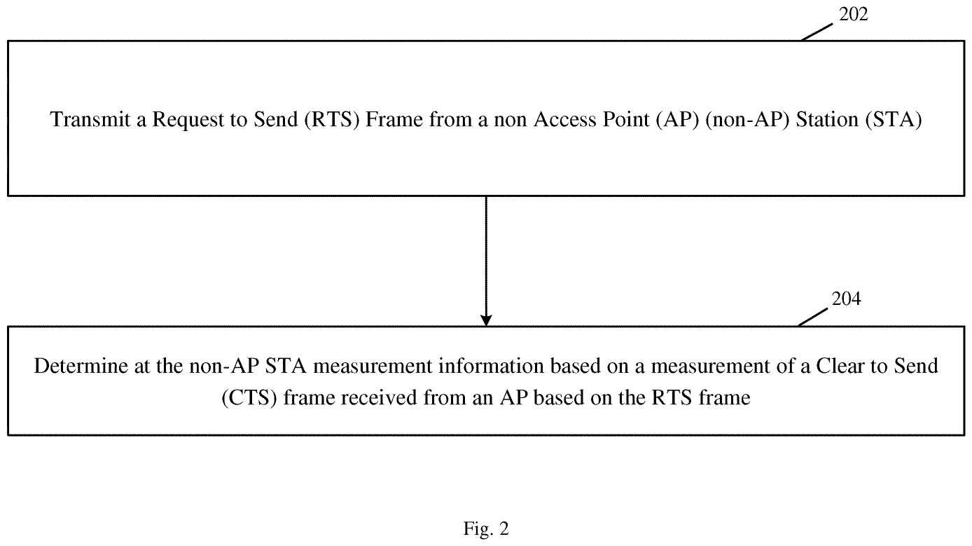

Reference is made to FIG. 2, which schematically illustrates a method of determining measurement information, in accordance with some demonstrative aspects. For example, one or more of the operations of the method of FIG. 2 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 202, the method may include transmitting an RTS frame from a non-AP STA. For example, controller 154 (FIG. 1) may be configured to cause, trigger, and/or control the non-AP STA implemented by device 140 (FIG. 1) to transmit the RTS frame, e.g., as described above.

As indicated at block 204, the method may include determining at the non-AP STA measurement information based on a measurement of a CTS frame received from an AP based on the RTS frame. For example, controller 154 (FIG. 1) may be configured to cause, trigger, and/or control the non-AP STA implemented by device 140 (FIG. 1) to determine measurement information based on a measurement of a CTS frame received from the AP implemented by device 102 (FIG. 1) based on the RTS frame, e.g., as described above.

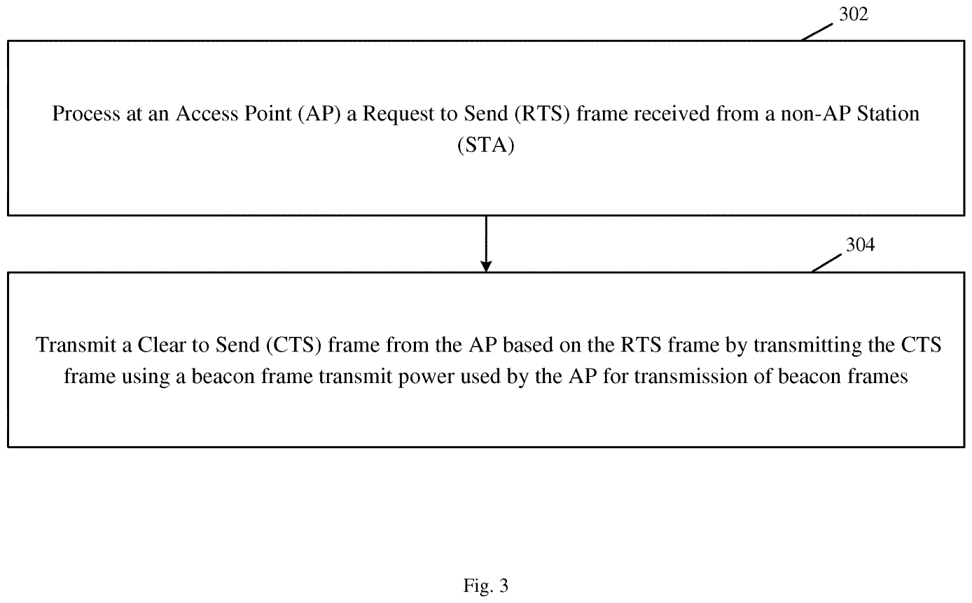

Reference is made to FIG. 3, which schematically illustrates a method of an RTS/CTS exchange, in accordance with some demonstrative aspects. For example, one or more of the operations of the method of FIG. 3 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 302, the method may include processing at an AP an RTS frame received from a non-AP STA. For example, controller 124 (FIG. 1) may be configured to cause, trigger, and/or control the AP implemented by device 102 (FIG. 1) to process an RTS frame received from the non-AP STA implemented by device 140, e.g., as described above.

As indicated at block 304, the method may include transmitting a CTS frame from the AP based on the RTS frame by transmitting the CTS frame using a beacon frame transmit power used by the AP for transmission of beacon frames. For example, controller 124 (FIG. 1) may be configured to cause, trigger, and/or control the AP implemented by device 102 (FIG. 1) to transmit the CTS frame using a beacon frame transmit power used by the AP for transmission of beacon frames, e.g., as described above.

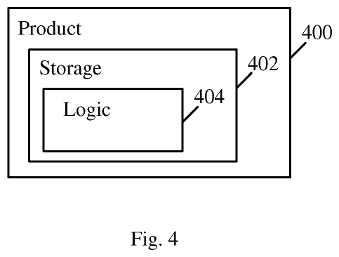

Reference is made to FIG. 4, which schematically illustrates a product of manufacture 400, in accordance with some demonstrative aspects. Product 400 may include one or more tangible computer-readable (“machine-readable”) non-transitory storage media 402, which may include computer-executable instructions, e.g., implemented by logic 404, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1-3, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 400 and/or machine readable storage media 402 may include one or more types of computer-readable storage media capable of storing data, including volatile memory, non-volatile memory, removable or non-removable memory, erasable or non-erasable memory, writeable or re-writeable memory, and the like. For example, machine readable storage media 402 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 404 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 404 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising a processor configured to cause a non Access Point (AP) (non-AP) station (STA) to transmit a Request to Send (RTS) frame; and determine measurement information based on a measurement of a Clear to Send (CTS) frame received from an AP based on the RTS frame; and a memory to store information processed by the processor.

Example 2 includes the subject matter of Example 1, and optionally, wherein the apparatus is configured to cause the non-AP STA to determine the measurement information based on measurement of a plurality of CTS frames from a plurality of APs.

Example 3 includes the subject matter of Example 1 or 2, and optionally, wherein the apparatus is configured to cause the non-AP STA to process the CTS frame to identify parameter information corresponding to a setting of one or more parameters of the AP.

Example 4 includes the subject matter of Example 3, and optionally, wherein the parameter information comprises bandwidth information of a Basic Service Set (BSS) operating bandwidth of the AP.

Example 5 includes the subject matter of Example 3 or 4, and optionally, wherein the parameter information comprises spatial stream information of one or more spatial streams utilized by the AP.

Example 6 includes the subject matter of any one of Examples 3-5, and optionally, wherein the parameter information comprises channel load information.

Example 7 includes the subject matter of any one of Examples 3-6, and optionally, wherein the parameter information comprises AP Multi Link Device (MLD) information corresponding to an AP MLD with which the AP is affiliated.

Example 8 includes the subject matter of any one of Examples 3-7, and optionally, wherein the parameter information comprises security information.

Example 9 includes the subject matter of any one of Examples 3-8, and optionally, wherein the apparatus is configured to cause the non-AP STA to process an information element from the AP to identify which parameter information is included in the CTS frame.

Example 10 includes the subject matter of any one of Examples 3-9, and optionally, wherein the apparatus is configured to cause the non-AP STA to transmit to the AP a request configured to indicate to the AP which requested parameter information is requested by the non-AP STA.

Example 11 includes the subject matter of any one of Examples 1-10, and optionally, wherein the RTS frame comprises a unicasted frame.

Example 12 includes the subject matter of any one of Examples 1-11, and optionally, wherein the RTS frame is addressed to the AP.

Example 13 includes the subject matter of any one of Examples 1-12, and optionally, wherein the CTS frame is separated from the RTS frame by a Short Inter Frame Space (SIFS).

Example 14 includes the subject matter of any one of Examples 1-13, and optionally, wherein the apparatus is configured to cause the non-AP STA to transmit a measurement report comprising the measurement information.

Example 15 includes the subject matter of any one of Examples 1-14, and optionally, wherein the apparatus is configured to cause the non-AP STA to transmit the RTS frame based on a request from a first AP, and to process the CTS frame received from a second AP.

Example 16 includes the subject matter of Example 15, and optionally, wherein the apparatus is configured to cause the non-AP STA to transmit the measurement information to the first AP.

Example 17 includes the subject matter of any one of Examples 1-17, and optionally, wherein the measurement information comprises power-measurement information based on a power measurement of the CTS frame.

Example 18 includes the subject matter of any one of Examples 1-18, and optionally, wherein the measurement information comprises energy information based on an energy measurement of the CTS frame.

Example 19 includes the subject matter of any one of Examples 1-19, and optionally, wherein the measurement information comprises Receive Signal Strength Indicator (RSSI) information based on an RSSI measurement of the CTS frame.

Example 20 includes the subject matter of any one of Examples 1-20, and optionally, comprising a radio to transmit the RTS frame and to receive the CTS frame, one or more antennas connected to the radio, and another processor to execute instructions of an operating system.

Example 21 includes an apparatus comprising a processor configured to cause an Access Point (AP) to process a Request to Send (RTS) frame received from a non-AP station (STA); and transmit a Clear to Send (CTS) frame based on the RTS frame by transmitting the CTS frame using a beacon frame transmit power used by the AP for transmission of beacon frames; and a memory to store information processed by the processor.

Example 22 includes the subject matter of Example 21, and optionally, wherein the apparatus is configured to cause the AP to configure the CTS frame comprising parameter information corresponding to a setting of one or more parameters of the AP.

Example 23 includes the subject matter of Example 22, and optionally, wherein the parameter information comprises bandwidth information of a Basic Service Set (BSS) operating bandwidth of the AP.

Example 24 includes the subject matter of Example 22 or 23, and optionally, wherein the parameter information comprises spatial stream information of one or more spatial streams utilized by the AP.

Example 25 includes the subject matter of any one of Examples 22-24, and optionally, wherein the parameter information comprises channel load information.

Example 26 includes the subject matter of any one of Examples 22-25, and optionally, wherein the parameter information comprises AP Multi Link Device (MLD) information corresponding to an AP MLD with which the AP is affiliated.

Example 27 includes the subject matter of any one of Examples 22-26, and optionally, wherein the parameter information comprises security information.

Example 28 includes the subject matter of any one of Examples 22-27, and optionally, wherein the apparatus is configured to cause the AP to transmit an information element configured to identify which parameter information is included in the CTS frame.

Example 29 includes the subject matter of any one of Examples 22-28, and optionally, wherein the apparatus is configured to cause the AP to process a request from the non-AP STA to identify which requested parameter information is requested by the non-AP STA.

Example 30 includes the subject matter of any one of Examples 21-29, and optionally, wherein the RTS frame comprises a unicasted frame.

Example 31 includes the subject matter of any one of Examples 21-30, and optionally, wherein the RTS frame is addressed to the AP.

Example 32 includes the subject matter of any one of Examples 21-31, and optionally, wherein the CTS frame is separated from the RTS frame by a Short Inter Frame Space (SIFS).

Example 33 includes the subject matter of any one of Examples 21-32, and optionally, comprising a radio to receive the RTS frame and to transmit the CTS frame, one or more antennas connected to the radio, and another processor to execute instructions of an operating system.

Example 34 includes a wireless communication device comprising the apparatus of any of Examples 1-33.

Example 35 includes a mobile device comprising the apparatus of any of Examples 1-33.

Example 36 includes an apparatus comprising means for executing any of the described operations of any of Examples 1-33.

Example 37 includes a product comprising one or more tangible computer-readable non-transitory storage media comprising instructions operable to, when executed by at least one processor, enable the at least one processor to cause any of the described operations of any of Examples 1-33.

Example 38 includes an apparatus comprising: a memory interface; and processing circuitry configured to: perform any of the described operations of any of Examples 1-33.

Example 39 includes a method comprising any of the described operations of any of Examples 1-33.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a processor configured to cause a non Access Point (AP) (non-AP) station (STA) to:
transmit a Request to Send (RTS) frame; and
determine measurement information based on a measurement of a Clear to Send (CTS) frame received from an AP based on the RTS frame; and
a memory to store information processed by the processor.

2. The apparatus of claim 1 configured to cause the non-AP STA to determine the measurement information based on measurement of a plurality of CTS frames from a plurality of APs.

3. The apparatus of claim 1 configured to cause the non-AP STA to process the CTS frame to identify parameter information corresponding to a setting of one or more parameters of the AP.

4. The apparatus of claim 3, wherein the parameter information comprises bandwidth information of a Basic Service Set (BSS) operating bandwidth of the AP.

5. The apparatus of claim 3, wherein the parameter information comprises spatial stream information of one or more spatial streams utilized by the AP.

6. The apparatus of claim 3, wherein the parameter information comprises channel load information.

7. The apparatus of claim 3, wherein the parameter information comprises at least one of AP Multi Link Device (MLD) information corresponding to an AP MLD with which the AP is affiliated, or security information.

8. The apparatus of claim 3 configured to cause the non-AP STA to process an information element from the AP to identify which parameter information is included in the CTS frame.

9. The apparatus of claim 3 configured to cause the non-AP STA to transmit to the AP a request configured to indicate to the AP which requested parameter information is requested by the non-AP STA.

10. The apparatus of claim 1, wherein the CTS frame is separated from the RTS frame by a Short Inter Frame Space (SIFS).

11. The apparatus of claim 1 configured to cause the non-AP STA to transmit a measurement report comprising the measurement information.

12. The apparatus of claim 1 configured to cause the non-AP STA to transmit the RTS frame based on a request from a first AP, and to process the CTS frame received from a second AP.

13. The apparatus of claim 12 configured to cause the non-AP STA to transmit the measurement information to the first AP.

14. The apparatus of claim 1, wherein the measurement information comprises at least one of power-measurement information based on a power measurement of the CTS frame, or energy information based on an energy measurement of the CTS frame.

15. The apparatus of claim 1, wherein the measurement information comprises Receive Signal Strength Indicator (RSSI) information based on an RSSI measurement of the CTS frame.

16. The apparatus of claim 1 comprising a radio to transmit the RTS frame and to receive the CTS frame, one or more antennas connected to the radio, and another processor to execute instructions of an operating system.

17. A product comprising one or more tangible computer-readable non-transitory storage media comprising instructions operable to, when executed by at least one processor, enable the at least one processor to cause a non Access Point (AP) (non-AP) station (STA) to:
transmit a Request to Send (RTS) frame; and
determine measurement information based on a measurement of a Clear to Send (CTS) frame received from an AP based on the RTS frame.

18. The product of claim 17, wherein the instructions, hen executed, cause the non-AP STA to transmit the RTS frame based on a request from a first AP, and to process the CTS frame received from a second AP.

19. An apparatus comprising:
a processor configured to cause an Access Point (AP) to:
process a Request to Send (RTS) frame received from a non-AP station (STA); and
transmit a Clear to Send (CTS) frame based on the RTS frame by transmitting the CTS frame using a beacon frame transmit power used by the AP for transmission of beacon frames; and
a memory to store information processed by the processor.

20. The apparatus of claim 19 configured to cause the AP to configure the CTS frame comprising parameter information corresponding to a setting of one or more parameters of the AP.
